(19) United States
(12) Patent Application Publication
(10) Pub. No.: US 2003/0216963 A1
(43) Pub. Date: Nov. 20, 2003

(54) Advertisement distribution processing system

(75) Inventors: Takuo Ishiwaka, Yokohama-shi (JP); Toshiro Muramatsu, Zushi-shi (JP)

Correspondence Address: SHINJYU GLOBAL IP COUNSELORS, LLP, 1233 20TH STREET, NW, SUITE 700, WASHINGTON, DC, 20036-2680, US

(73) Assignee: Nissan Motor Co., Ltd., Yokohama (JP)

(21) Appl. No.: 10/397,279

(22) Filed: Mar. 27, 2003

(30) Foreign Application Priority Data
May 20, 2002 (JP) JP 2002-145306

(51) Int. Cl. G06F 17/60

(52) U.S. Cl. 705/14

(57) ABSTRACT

An advertisement distribution device is configured to accurately analyze the effect of a distributed advertisement. The advertisement distribution device distributes advertisements to a mobile communication terminal, which presents the distributed advertisement to a user. The advertisement distribution device associates advertisement content information of the advertisement with area information that indicates an area where the advertisement will be distributed or presented. When a mobile communication terminal position acquiring section detects that the mobile communication terminal is positioned inside the distribution or presentation area, the advertisement distribution device distributes the advertisement content information corresponding to the area information for the area. The advertisement distribution device then receives operation content information describing the operations performed on the mobile communication terminal with respect to the advertisement. An advertising effect determining section then analyzes the advertising effect based on this operation content.

### BACKGROUND OF THE INVENTION

1. Field of the Invention

The present invention relates to an advertisement distribution processing system, an advertisement distribution processing device and method, a communication terminal, and an advertisement presentation method for distributing advertisement information and determining the advertising effect of the distributed advertisement information.

2. Background Information

An advertisement distribution system is disclosed in Japanese Laid-Open Patent Publication No. 2001-134650 in which an advertisement is distributed electronically based on position information indicating where a mobile body terminal exists and the advertising effect is confirmed by determining whether or not the user actually visited the advertised store. With this type of advertisement distribution system, the effect of the distributed advertisement is analyzed based on time information and position information indicating where the mobile body terminal exists. In other words, this advertisement distribution system analyzes the advertising effect by determining how much time the mobile body terminal spent in a position corresponding to the distributed advertisement. For example, if a restaurant advertisement was distributed, a designated geographical area (such as the parking lot of the restaurant) is held in advance as position information and the system analyzes that the user indeed visited the restaurant when the position of the mobile body terminal and the position information of the restaurant that was held in advance match or are close to each other for a prescribed amount of time, e.g., 30 minutes.

In view of the above, it will be apparent to those skilled in the art from this disclosure that there exists a need for an improved advertisement distribution processing system. This invention addresses this need in the art as well as other needs, which will become apparent to those skilled in the art from this disclosure.

### SUMMARY OF THE INVENTION

It has been discovered that with an advertisement distribution system that analyzes the advertising effect in the manner just described, even if only advertisement information for a restaurant was distributed, it would be impossible to determine which store was visited in a situation where the position used to determine if the restaurant was visited is a parking lot of a complex facility that actually includes other stores or facilities such as a sports facility and a supermarket in addition to the restaurant. Furthermore, even if the user visits the restaurant, the user will not necessarily park the vehicle in the parking lot designated by the store supplying the advertisement. Therefore, this system is problematic in that it cannot accurately determine if a store was actually visited and cannot accurately analyze the advertising effect.

The present invention was conceived in view of the aforementioned problems and its object is to provide an advertisement distribution processing system, an advertisement distribution processing device, a communication terminal, and an advertisement presentation method that can accurately analyze the advertising effect of distributed advertisement information.

In order to achieve the aforementioned object, an advertisement distribution processing system is provided that comprising a communication terminal and an advertisement distribution device. The communication terminal is configured to receive advertisement content information and present to a user an advertisement based on the advertisement content information. The advertisement distribution device is configured to associate and store in advance the advertisement content information and area information indicating an area where the advertisement will be presented. The advertisement distribution device is further configured to distribute the advertisement content information corresponding to the area information of the area to the communication terminal when the communication terminal is located within the area. The advertisement distribution device is further configured to detect operation content created by operations performed on the communication terminal in response to the advertisement, and analyze an advertising effect based on the operation content.

These and other objects, features, aspects and advantages of the present invention will become apparent to those skilled in the art from the following detailed description, which, taken in conjunction with the annexed drawings, discloses preferred embodiments of the present invention.

### BRIEF DESCRIPTION OF THE DRAWINGS

Referring now to the attached drawings which form a part of this original disclosure:

FIG. 1 is a block diagram showing the functional components of an advertisement distribution device for an advertisement distribution system in accordance with a first embodiment of the present invention;

FIG. 2 is a block diagram showing the functional components of a mobile communication terminal for the advertisement distribution system in accordance with the first embodiment of the present invention;

FIG. 3 is a flowchart for illustrating a first part of the advertisement distribution processing executed by the advertisement distribution system in accordance with the first embodiment of the present invention;

FIG. 4 is a flowchart for illustrating a second part of the advertisement distribution processing executed by the advertisement distribution system in conjunction with the first part illustrated in FIG. 3 in accordance with the first embodiment of the present invention;

FIG. 5 is a flowchart for illustrating a third part of the advertisement distribution processing executed by the advertisement distribution system in conjunction with the first and second parts illustrated in FIGS. 3 and 4 in accordance with the first embodiment of the present invention;

FIG. 6 is a block diagram showing the functional components of an advertisement distribution device for an advertisement distribution system in accordance with a second embodiment of the present invention;

FIG. 7 is a block diagram showing the functional components of a mobile communication terminal for the advertisement distribution system in accordance with a second embodiment of the present invention;

FIG. 8 is a flowchart for illustrating a second part of the advertisement distribution processing executed by the advertisement distribution system in conjunction with the first part illustrated in FIG. 3 in accordance with the second embodiment of the present invention;

FIG. 9 is a flowchart for illustrating a third part of the advertisement distribution processing executed by the advertisement distribution system in conjunction with the first and second parts illustrated in FIGS. 3 and 8 in accordance with the second embodiment of the present invention;

FIG. 10 is a flowchart for illustrating a second part of the advertisement distribution processing executed by the advertisement distribution system in conjunction with the first part illustrated in FIG. 3 in accordance with the third embodiment of the present invention;

FIG. 11 is a flowchart for illustrating a third part of the advertisement distribution processing executed by the advertisement distribution system in conjunction with the first and second parts illustrated in FIGS. 3 and 10 in accordance with the third embodiment of the present invention;

FIG. 12 is a block diagram showing the functional components of an advertisement distribution system in accordance with a fourth embodiment of the present invention; and

FIG. 13 is a block diagram a block diagram showing the functional components of an advertisement distribution device in accordance with the fourth embodiment of the present invention.

### DETAILED DESCRIPTION OF THE PREFERRED EMBODIMENTS

Four selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents. In view of the similarity between the embodiments, the portions of the embodiments that are identical will be given the same reference numerals or symbols. Thus, the descriptions of the portions of the later embodiments that are identical to the portions of the first embodiment may be omitted for the sake of brevity.

Basically, each of the advertisement distribution systems of these embodiments includes a mobile communication terminal and an advertisement distribution device 1 and a plurality of mobile communication terminals 2 (only one shown) that are connected together through a wireless network in a fully automated manner. In each of the advertisement distribution systems of these embodiments, advertisement content information is distributed from the advertisement distribution device 1 to the mobile communication terminals 2, which move with various users. Thus, in the embodiments as explained below the mobile communication terminals 2 are either mounted in vehicles and/or part of a hand held device such that the mobile communication terminals 2 move with the users. It will also be apparent to those skilled in the art from this disclosure that the mobile communication terminals 2 can be stationary communication terminals which are mounted in areas accessible to users as needed and/or desired.

With the advertisement distribution processing systems of the present invention, as explained below in more detail, when the mobile communication terminal 2 is positioned within a presentation area, advertisement content information corresponding to area information of the area is distributed to the mobile communication terminal 2. Next, operation of the mobile communication terminal 2 in response to advertisement is detected. Then, the advertising effect is analyzed based on this operation content. As a result, the system can accurately analyze the advertising effect of the distributed advertisements.

### First Embodiment

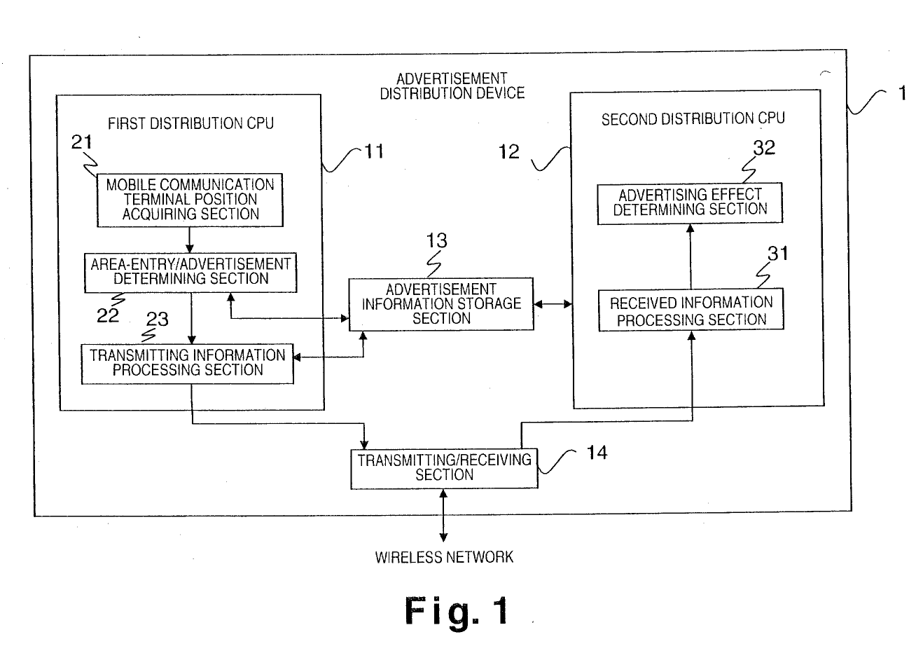

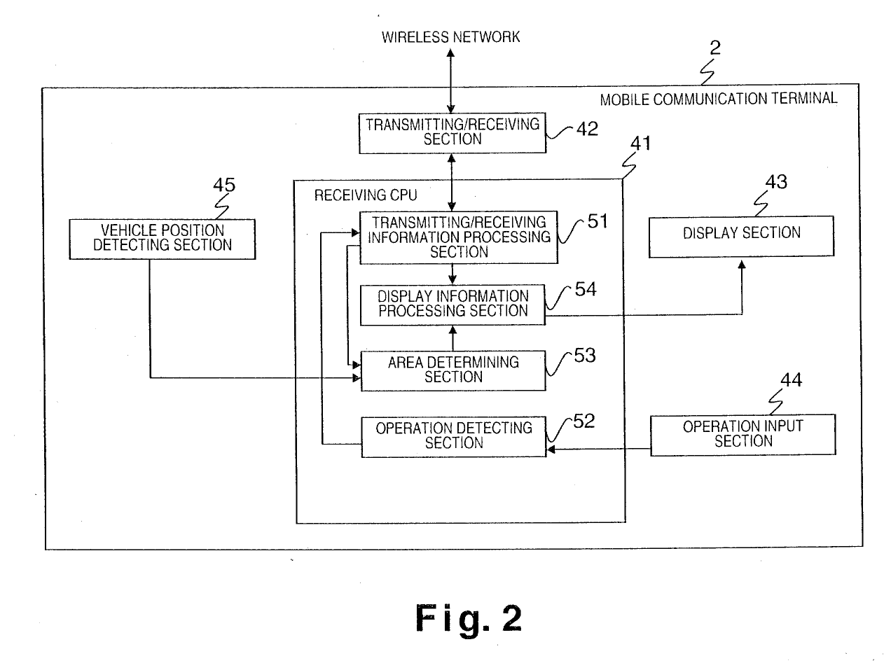

Referring initially to FIGS. 1 and 2, the advertisement distribution device 1 and one of the mobile communication terminals 2 of a first embodiment of the present invention are illustrated. As seen in FIG. 1, the advertisement distribution device 1 is managed by, for example, an advertisement distribution company and functions as a server with respect to the mobile communication terminals 2. The advertisement distribution device 1 preferably has two central processing units (CPU), i.e., a first distribution CPU 11 and a second distribution CPU 12, that carry out the functions described later by reading programs from a program storage section (not shown). The advertisement distribution device 1 also has an the advertisement information storage section 13 that stores advertisement information to be distributed to the mobile communication terminals 2 and a transmitting/receiving section 14 that communicates with the mobile communication terminals 2 through a wireless network.

The distribution CPUs 11 and 12 preferably includes a microcomputer with suitable control programs for carrying out the processes of advertisement distribution device 1 as discussed below. The distribution CPUs 11 and 12 also include other conventional components such as an input interface circuit, an output interface circuit, and storage devices such as a ROM (Read Only Memory) device and a RAM (Random Access Memory) device. It will be apparent to those skilled in the art from this disclosure that the precise structure and algorithms for the distribution CPUs 11 and 12 can be any combination of hardware and software that will carry out the functions of the present invention. In other words, “section plus function” clauses as utilized in the specification and claims should include any structure or hardware and/or algorithm or software that can be utilized to carry out the function of the “section plus function” clause.

The advertisement information storage section 13 has, for example, a large-scale information storage function and stores advertisement information. For example, the advertisement information storage section 13 stores information of advertisers that have requested advertisement information to be distributed. The advertisement information storage section 13 correlates and stores the various types of advertisement information including, but not limited to, advertisement content information to be presented to a user, distribution area information indicating a distribution area where the advertisement content information will be distributed, and presentation area information indicating a presentation area where an advertisement will be presented using the advertisement content information. The advertisement content information includes, but not limited to, summary advertisement information for presenting a summary of the advertisement (advertisement summary) and detailed advertisement information for presenting the details of the advertisement. The detailed advertisement information includes, but not limited to, display information for presenting a detailed advertisement that is more detailed than the summary advertisement and selectable display content or items, such as icons, that the user can select with the display screen.

The presentation area is set to be a smaller area than the distribution area with which it was associated by the advertisement information storing section 13, and includes, for example, stores targeted by the advertisement. The distribution area and presentation area are designated by the advertiser in advance along with the advertisement content information.

Based on the request from the advertiser, the content of the advertisement information is registered and edited by the advertisement distribution device 1. Each set of advertisement information also includes distribution history information for identifying whether or not it was distributed from the advertisement distribution device 1 to the mobile communication terminals 2. The distribution history information comprises an ID signal for each of the mobile communication terminals 2. The ID signal individually identifies a particular one of the mobile communication terminals 2 within a distribution destination for which distribution of the advertisement information is complete and information that identifies whether or not distribution is incomplete or complete. Distribution history information is provided for both the detailed advertisement information and the summary advertisement information.

The transmitting/receiving section 14 includes communication interface circuitry that connects and exchanges information with a plurality of the mobile communication terminals 2 through a wireless network. The transmitting/receiving section 14 converts the information from the first distribution CPU 11 into a prescribed signal format and transmits it to the mobile communication terminals 2 through a wireless network. The transmitting/receiving section 14 also changes the received information into a signal format that can be processed by the second distribution CPU 12, as explained in more detail below, and outputs the information thereto. The transmitting/receiving section 14 performs processing adapted to a communication protocol of, for example, a portable telephone.

The first distribution CPU 11 has the following functional components: a mobile communication terminal position acquiring section 21, an area-entry/advertisement determining section 22, and a transmitting information processing section 23.

The mobile communication terminal position acquiring section 21 functions to acquire the position of the vehicle or hand held device in which one of the mobile communication terminals 2 is installed. The mobile communication terminal position acquiring section 21 acquires position information by, for example, utilizing a position information service provided by a communications company (such network services are gaining popularity as commercial services) to read the position information transmitted by the navigation system of the vehicle. The mobile communication terminal position acquiring section 21 acquires the position information in a regular fashion as needed and/or desired.

The area-entry/advertisement determining section 22 compares the distribution area indicated by the distribution area information stored in the advertisement information storage section 13 with the position information acquired by the mobile communication terminal position acquiring section 21 and determines if the vehicle or hand held device with the mobile communication terminal 2 is inside the distribution area. When it determines that the vehicle or hand held device has entered the distribution area registered by the distribution area information, the area-entry/advertisement determining section 22 determines which advertisement content information relate to the distribution area information that indicates the corresponding distribution area and sends the determination result to the transmitting information processing section 23.

The transmitting information processing section 23 reads advertisement information from the advertisement information storage section 13 based on the determination result produced by the area-entry/advertisement determining section 22. The transmitting information processing section 23 then arranges the advertisement information it read into an information structure for distribution to the mobile communication terminals 2 and sends the advertisement information to the transmitting/receiving section 14.

The second distribution CPU 12 includes a received information processing section 31 and an advertising effect determining section 32 as its main functional components. The received information processing section 31 analyses the data received through the transmitting/receiving section 14. The advertising effect determining section 32 analyzes quantitatively the advertising effect with respect to the user based on that data among the data received by the received information processing section 31 that were generated by viewing or hearing the advertisement on the mobile communication terminals 2.

Now referring to FIG. 2, one of the mobile communication terminals 2 is illustrated that is installed in a vehicle, which is managed by the user, and functions as a client with respect to the advertisement distribution device 1. Of course, it will be apparent to those skilled in the art from this disclosure that the mobile communication terminal 2 can be a part of a hand held device. Each of the mobile communication terminals 2 includes a receiving CPU 41 that carries out the functions described later by reading programs from a program storage section (not shown). The main functional sections of the receiving CPU 41 are a transmitting/receiving information processing section 51, an operation detecting section 52, an area-entry determining section 53, and a display information processing section 54. Each of the mobile communication terminals 2 also has the following sections: a transmitting/receiving section 42 that communicates with the advertisement distribution device 1 through a wireless network, a display section 43, an operation input section 44, and a vehicle position detecting section 45.

When the transmitting/receiving section 42 receives advertisement information from the advertisement distribution device 1, the mobile communication terminal 2 sends the advertisement information to the transmitting/receiving information processing section 51. The transmitting/receiving information processing section 51 then converts the advertisement content information portion of the advertisement information into a signal format that can be processed by the display information processing section 54 and sends the information to the display information processing section 54. Similarly, the transmitting/receiving section information processing section 51 converts the presentation area information into a signal format that can be processed by the area-entry determining section 53 and sends the information to the area-entry determining section 53.

When the vehicle is traveling, the mobile communication terminal 2 detects the vehicle position through the vehicle position detecting section 45 using the position measuring function of the navigation system installed in the vehicle and sends the vehicle position information to the area-entry determining section 53. The vehicle position detecting section 45 creates vehicle position information each time, for example, a prescribed amount of time elapses while the vehicle is traveling, i.e., the mobile communication terminal 2 is moving.

When the area-entry determining section 53 receives the vehicle position information, the area-entry determining section 53 determines if the vehicle position is within the presentation area indicated by the presentation area information already received. If the vehicle position is within the presentation area, the area-entry determining section 53 controls the display information processing section 54 so as to process the advertisement content information received together with the presentation area information. In response, the display information processing section 54 controls the display section 43 to display the advertisement. As a result, the mobile communication terminal 2 completes the advertisement distribution.

When advertisement information for several advertisements are received from the transmitting/receiving section information processing section 51, several sets of advertisement content information are stored in the display information processing section 54 and several sets of presentation area information are stored in the area-entry determining section 53. From this state, the area-entry determining section 53 continually compares each presentation area with the vehicle position to the sets of presentation area information stored in the area-entry determining section 53. When the vehicle enters one of the presentation areas that matches with one of the sets of the presentation area information stored in the area-entry determining section 53 for a particular advertisement content information stored in the display information processing section 54, the area-entry determining section 53 controls the display information processing section 54 to display the advertisement(s) corresponding to that presentation area on the display section 43.

Preferably, the display section 43 is a display device, such as the liquid crystal display of the navigation system. In addition to the advertisement, the display section 43 preferably displays the current position of the vehicle, the destination, and the recommended route while the vehicle is traveling. This embodiment demonstrates a case in which only the display section 43 is used to present the advertisement, but the invention is not limited to such an arrangement. It is also acceptable for the advertisement to be present by sound or other suitable communication method.

Moreover, preferably, each of the mobile communication terminal 2 is configured to permit to viewer to response to special offers, privileges and services that the user can receive in connection with the advertisements. The user selects the special offers, privileges and/or services that he or she wants to receive by operating the operation input section 44. Thus, when the mobile communication terminal 2 is turned on, the user performs such tasks as changing the displayed content of the display section 43 as well as requesting advertisement information by operating the operation input section 44, which comprises buttons, dials, and the like. These inputting operations performed on the operation input section 44 are detected by the operation detecting section 52 and operation input information occurring when advertisement content information is being displayed are transmitted to the advertisement distribution device 1 through the transmitting/receiving information processing section 51 and the transmitting/receiving section 42. More specifically, when advertisement content information is displayed with offers, privileges and/or services as selectable content that the user can receive in connection with the advertisements, the user selects services that he or she wants to receive by operating the operation input section 44. Then, the selected content is transmitted to the advertisement distribution device 1 as operation inputting information. Since each mobile communication terminal 2 has it own unique ID, the user can be easily identified to deliver the offers, privileges and/or services.

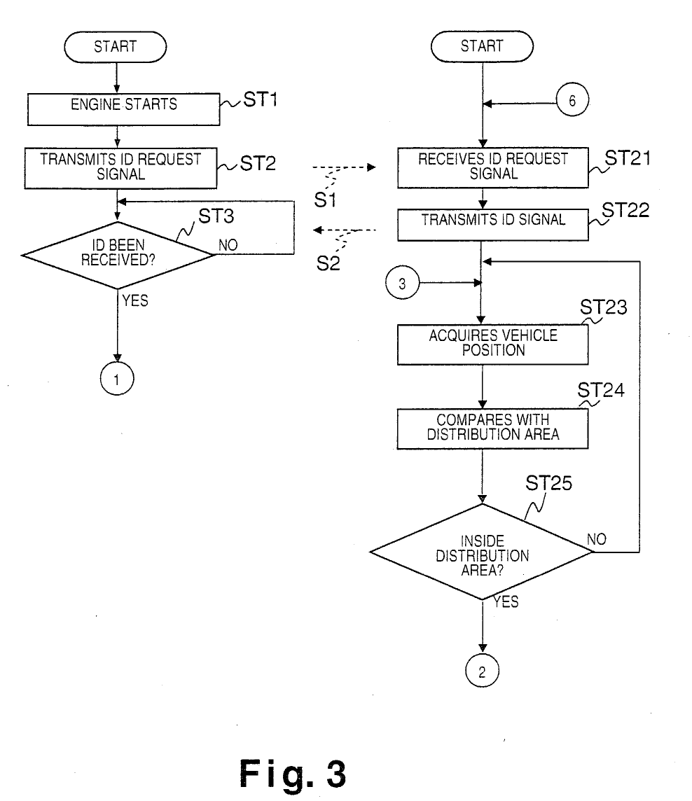

Next, the processing steps executed by the advertisement distribution system are explained in reference to the flowcharts shown in FIGS. 3-5. First, in step ST1, the engine of the vehicle is started and the mobile communication terminal 2 starts up. In response, the processing proceeds to step ST2 where a request S1 for assignment of a unique ID for the mobile communication terminal 2 is sent from the mobile communication terminal 2 to the advertisement distribution device 1 via the wireless network. Then, processing proceeds to step ST3.

Meanwhile, the advertisement distribution device 1 receives a request S1 via the transmitting/receiving section 14 in step ST21. The advertisement distribution device 1 then calculates an ID signal S2 with the unique ID to be temporarily allocated for use in subsequent communications. The advertisement distribution device 1 then transmits the ID signal to the mobile communication terminal 2 through the transmitting/receiving section 14 via the wireless network. When transmission of the ID signal has been completed, processing proceeds to step ST23. In step ST23, the mobile communication terminal position acquiring section 21 acquires the current position of the vehicle with the mobile communication terminal 2 to which the ID signal was assigned.

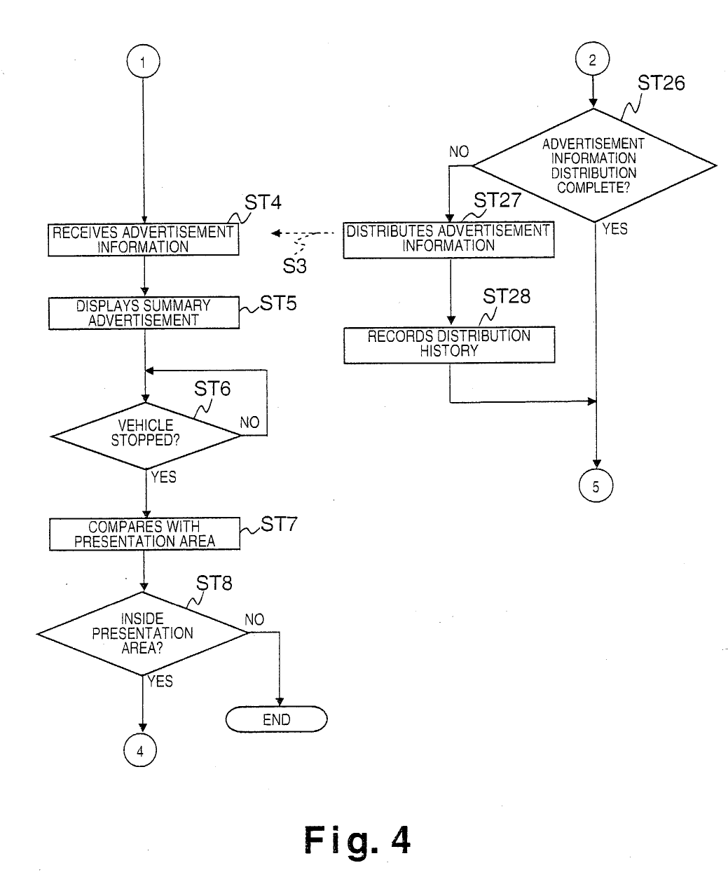

Next, in step ST24, the vehicle position acquired in step ST23 is compared with the distribution area for each set of advertisement information stored in the advertisement information storage section 13. In step ST25, the advertisement distribution device 1 determines if the vehicle position is within one of the distribution areas for one of the sets of advertisement information stored in the advertisement information storage section 13. If the advertisement distribution device 1 determines that the vehicle position is not within any of the distribution areas, then processing returns to step ST23 to repeat the cycle. If the advertisement distribution device 1 determines that the vehicle position is within one of the distribution areas, then processing proceeds to step ST26 (shown in FIG. 4). As a result, the advertisement distribution device 1 continually monitors the vehicle position and shifts to the processing described below when the advertisement distribution device 1 determines that the vehicle position is within one of the distribution areas.

In step ST26, the advertisement distribution device 1 checks the distribution history to determine if the advertisement distribution device 1 has completed transmission of the advertisement information corresponding to the distribution area information for the distribution area in which the vehicle was determined to be positioned in step ST25. If there is any advertisement information that should be distributed, processing proceeds to step ST27 where advertisement information S3 is read from the advertisement information storage section 13 and distributed to the mobile communication terminal 2 via the wireless network. Then, processing proceeds to step ST28 and where the distribution history inside the advertisement information storage section 13 is recorded.

Meanwhile, when the mobile communication terminal 2 receives the ID signal S2, the mobile communication terminal 2 determines that it has received the ID signal through the transmitting/receiving section 42 in step ST3 of FIG. 3. Then, the processing proceeds to step ST4. In step ST4, the mobile communication terminal 2 receives the advertisement information transmitted in step ST27. Then, the processing proceeds to step ST5 where the mobile communication terminal 2 displays the summary advertisement contained in the advertisement information on the display section 43. Thus, summary advertisement can be presented to the user while the vehicle is within the distribution area. For example, a summary advertisement is only the headline portion, e.g., “Huge Sale at xx” of the detailed advertisement.

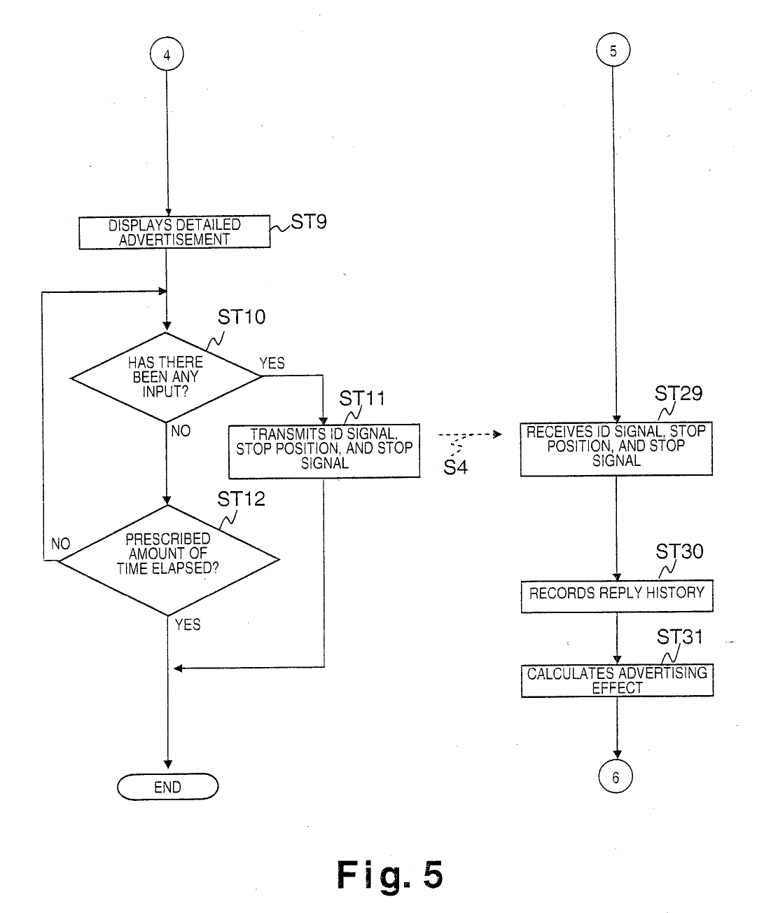

After such a summary advertisement is presented to the user, in step ST6, the mobile communication terminal 2 detects if the vehicle has stopped by using, for example, vehicle position detection section 45. If the vehicle has stopped, processing proceeds to step ST7 where the area-entry determining section 53 compares the vehicle position where the vehicle is stopped to the presentation area indicated in the presentation area information contained in the received advertisement information. In step ST8, the mobile communication terminal 2 determines if the vehicle position where the vehicle is stopped is within the presentation area. If not, the processing is ended. If the vehicle stops within the presentation area, the processing proceeds to step ST9 (shown in FIG. 5) and where the display information processing section 54 is controlled so as to display the detailed advertisement.

The phrases “vehicle stopping”, “vehicle is stopped” and the like as mentioned herein refers to any one or a combination of the following conditions, which are related to the vehicle stopping: the vehicle speed is below a prescribed value, e.g., 5 km/h; the engine has been stopped; a signal indicates that the key has been removed; the shift lever has been put into the “Park” position; the parking brake has been engaged; motorized mirrors have been retracted into the storage state; the vehicle has be shifted into reverse gear; and the like.

Thus, detailed advertisements can be presented on the display section 43 when the vehicle has stopped inside the presentation area. A detailed advertisement comprises advertising content that is more detailed than the summary advertisement and contains such information as, “All Household Electric Appliances 20% Off. Preferred Privileges for Credit Card Holders.” In step ST9, in addition to a detailed advertisement, selectable content is displayed that prompts the user to input selections using the operation input section 44. Examples of selectable content include displays that prompt selections, such as “The following credit cards can be used: ◯◯, ΔΔ, and xx. Special privileges are associated with each of these cards. Which card's information would you like to view?”. Moreover, the display section 43 displays payment information by a settlement or payment display that allow the user to select cash payment or credit card payment using the operation input section 44. Other selectable displays that can be displayed on the display section 43 include exchanges regarding directions to a sales location, business hours, and whether or not pets are allowed in the store. When such items are selected, more detailed content is displayed regarding the selected item on the display section 43.

After a detailed advertisement and selectable content have been displayed, the mobile communication terminal 2 determines in step ST10 if the operation input section 44 has been operated and a selectable display has been selected. If so, processing proceeds to step ST11 where operation input information S4 is transmitted as a signal from the mobile communication terminal 2 to the advertisement distribution device 1. Preferably, the following information is also transmitted with the operation input information S4 to the advertisement distribution device 1: the ID signal for each the mobile communication terminal 2, a stop signal indicating that the vehicle has stopped, and the vehicle position where the vehicle is stopped. Then, processing for the mobile communication terminal 2 ends.

If the mobile communication terminal 2 determines in step ST10 that no operation input occurred, the processing proceeds to step ST12 where the mobile communication terminal 2 determines if a prescribed amount of time has elapsed. If the prescribed amount of time has elapsed, processing for the mobile communications terminal 2 ends.

In step ST11, the ID signal, the stop signal, the vehicle's stopped position, and operation input information S4 from step ST10 are transmitted from the mobile communication terminal 2 to the advertisement distribution device 1. When these items are received by the advertisement distribution device 1, processing proceeds to step ST29 where the received information is sent from the transmitting/receiving section 14 to the received information processing section 31.

Next, in step ST30, a history indicating that there was a reply to the operation input information is recorded in the advertisement information storage section 13. In step ST31, the advertising effect determining section 32 analyzes the effect of the advertisement distribution using the information that the advertisement distribution device 1 has received from the mobile communication terminal 2. Then, the processing returns to step ST21 (FIG. 3) to repeat the above-described process.

When the advertising effect is analyzed in step ST31, the advertising effect determining section 32 determines that the mobile communication terminal 2 (advertisement distribution destination) stopped in the presentation area based on the stop signal and the vehicle's stopped position. Furthermore, the advertising effect determining section 32 determines that the advertisement had an effect when the operation input information indicates that operations were performed in response to the detailed advertisement. More specifically, when the vehicle stops in the area designated by the advertiser and the user performs operations to select an advertised offer, privilege, and/or service, the advertising effect determining section 32 assumes that the user intends to visit the store and determines that the advertising effect on the user was high. The present invention is not limited to this method. For example, it is also acceptable to analyze the advertising effect using another method.

### Effects of First Embodiment

As described in detail previously, in the first embodiment of the advertisement distribution system, advertisement information is distributed from the advertisement distribution device 1 to one of the mobile communication terminals 2 when the vehicle enters the distribution area. After the summary advertisement has been presented to the user, the detailed advertisement is presented when the mobile communication terminal 2 determines that its vehicle has entered the presentation area. The advertisement distribution device 1 is able to accurately analyze the advertising effect because operations performed by the user after the detailed advertisement was presented are detected and transmitted to the advertisement distribution device 1. In short, when the advertisement advertises a store or the like, the advertisement distribution system can more accurately determine if the user actually intends to visit the store.

This advertisement distribution system can also detect the operations of the user with respect to the advertisement in a reliable manner. Thus, this advertisement distribution system can analyze the advertising effect with more certainty by detecting a stopping operation of the vehicle or a similar operation, such as engaging the parking brake within the presentation area.

Furthermore, since this advertisement distribution system displays selectable content along with the detailed advertisement, the user can be prompted to perform input operations regarding the services offered by the advertiser, making it possible to analyze the advertising effect while simultaneously spreading knowledge of the service content.

This embodiment serves as an example of a case in which the advertisement information is distributed when the mobile communication terminal 2 is inside a distribution area, but the invention is not limited to such a case. For example, it is also acceptable to have an arrangement in which the mobile communication terminal position acquiring section 21 of the advertisement distribution device 1 acquires information regarding a recommended route set up by a navigation system installed in the vehicle and distributes advertisement information when the recommended route passes through the distribution area.

By adding the case in which the recommended route passes through the distribution area to the advertisement information distribution conditions, advertisement information can be distributed to a larger number of the mobile communication terminals 2. Thus, this advertisement distribution system can more accurately analyze the advertising effect can be accomplished by detecting operations with respect to a larger number of detailed advertisements.

Of course, it will be apparent to those skilled in the art from this disclosure that the advertisement distribution device 1 can determine many other effects of the displayed advertisement on the user of the mobile communication terminal 2. For example, the advertisement distribution device 1 can analyze how long after the summary advertisement was presented to the user, did the user's vehicle stop at the presentation area.

### Second Embodiment

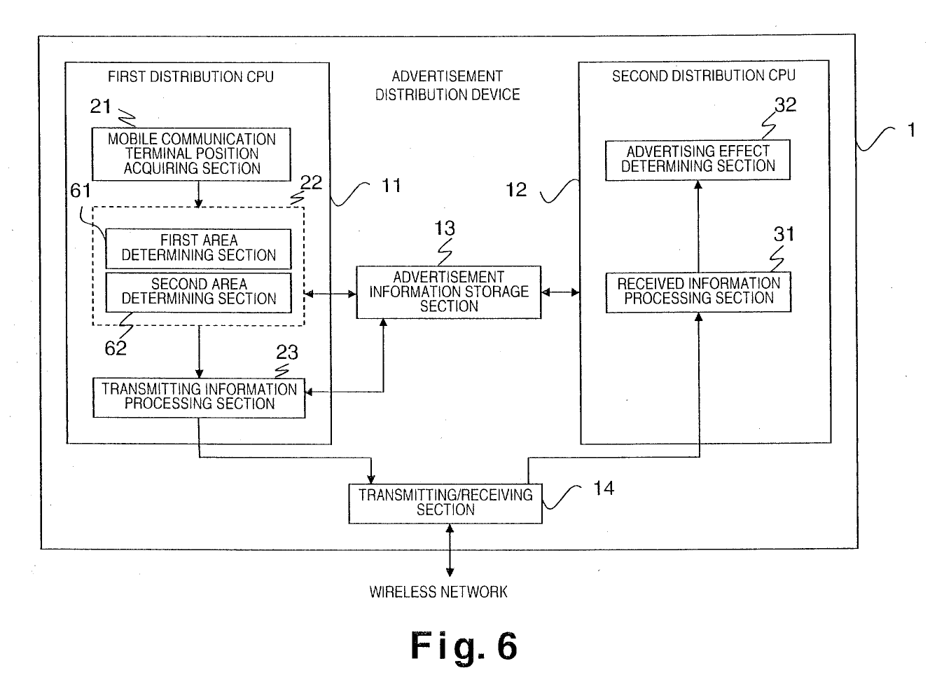

Referring now to FIGS. 6-9, an advertisement distribution system in accordance with a second embodiment will now be explained. Regarding portions of the second embodiment that are the same as the first embodiment, the same reference symbols and the same step numbers are used. Also the detailed explanations of these repeated portions are omitted.

The second embodiment of the advertisement distribution system basically the same as the first embodiment, except in one basic respect. In particular, in the advertisement distribution system of the second embodiment, the advertisement distribution device 1 first distributes summary advertisement information to the mobile communication terminals 2 (which present the summary advertisement to the user) when the vehicle has entered a first distribution area. Then, the advertisement distribution device 1 distributes detailed advertisement information to the mobile communication terminals 2 (which presents the detailed advertisement to the user) when the vehicle has entered a second distribution area disposed within the first distribution area.

As shown in FIG. 6, the area-entry/advertisement determining section 22 of the advertisement distribution device 1 in the second embodiment comprises a first area determining section 61 and a second area determining section 62. Also, in the second embodiment, the advertisement information stored in the advertisement information storage section 13 comprises the following information, which have been associated with one another: first distribution area information that defines the scope of the first distribution area, second distribution area information that defines the scope of the second distribution area, summary advertisement information, and detailed advertisement information. In the second embodiment, it is also acceptable for the presentation area information that is transmitted to the mobile communication terminal 2 not to be registered in the advertisement information storage section 13.

In the area-entry/advertisement determining section 22, the position information from the mobile communication terminal position acquiring section 21 is used by the first area determining section 61 to determine if the vehicle is in the first distribution area. Also, in the area-entry/advertisement determining section 22, the position information from the mobile communication terminal position acquiring section 21 is used by the second area determining section 62 to determine if the vehicle is in the second distribution area.

When the area-entry/advertisement determining section 22 determines that the vehicle has entered the first distribution area registered in the advertisement information storage section 13, the first area determining section 61 then determines which summary advertisement information is related to the corresponding first distribution area information and sends the determination result to the transmitting information processing section 23. As a result, the transmitting information processing section 23 reads the summary advertisement information when the vehicle is positioned within the first distribution area and distributes the summary advertisement information to the mobile communication terminal 2, where the summary advertisement is presented.

Meanwhile, when the area-entry/advertisement determining section 22 determines that the vehicle has entered the second distribution area registered in the advertisement information storage section 13, the second area determining section 62 then determines which detailed advertisement information is related to the corresponding second distribution area information and sends the determination result to the transmitting information processing section 23. As a result, the transmitting information processing section 23 reads the detailed advertisement information when the vehicle is positioned within the second distribution area. The transmitting information processing section 23 then distributes the detailed advertisement information to the mobile communication terminal 2, where the detailed advertisement is presented to the user of the mobile communication terminal 2.

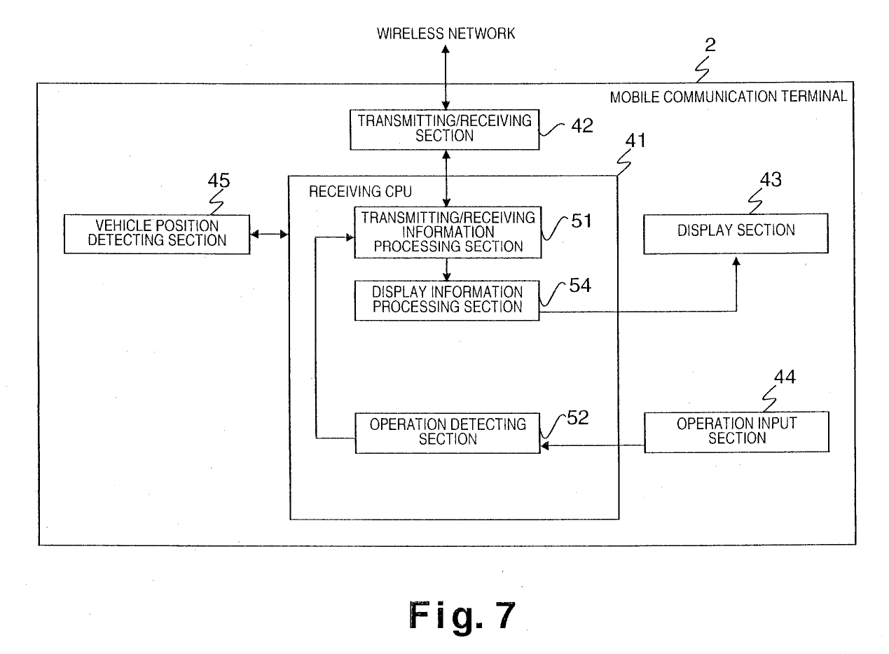

As shown in FIG. 7, the mobile communication terminal 2 receives the advertisement information from the advertisement distribution device 1 in the same manner as the first embodiment. However, this second embodiment differs from the first embodiment in that the mobile communication terminal 2 does not have the area-entry determining section 53 of the first embodiment. When this mobile communication terminal 2 of this second embodiment receives the summary advertisement information through the transmitting/receiving section 42, the mobile communication terminal 2 has the display information processing section 54 perform the same processing described earlier and presents summary advertisement. The mobile communication terminal 2 then receives the detailed advertisement information and presents the detailed advertisement when the vehicle is stopped or when the user operates the operation input section 44. After the mobile communication terminal 2 presents the detailed advertisement, the mobile communication terminal 2 detects operations of the operation input section 44 and creates operation input information by using the operation detecting section 52.

Next, the advertisement distribution processing executed by the second embodiment of the advertisement distribution system is explained in reference to FIGS. 3, 8 and 9. First, the second embodiment of the advertisement distribution system executes the process illustrated in FIG. 3 in the same manner as the first embodiment, as previously described, except that step ST25 of FIG. 3 is conducted by the first area determining section 61 in this second embodiment. In step ST25 of FIG. 3, the first area determining section 61 determines if the vehicle position is within the first distribution area.

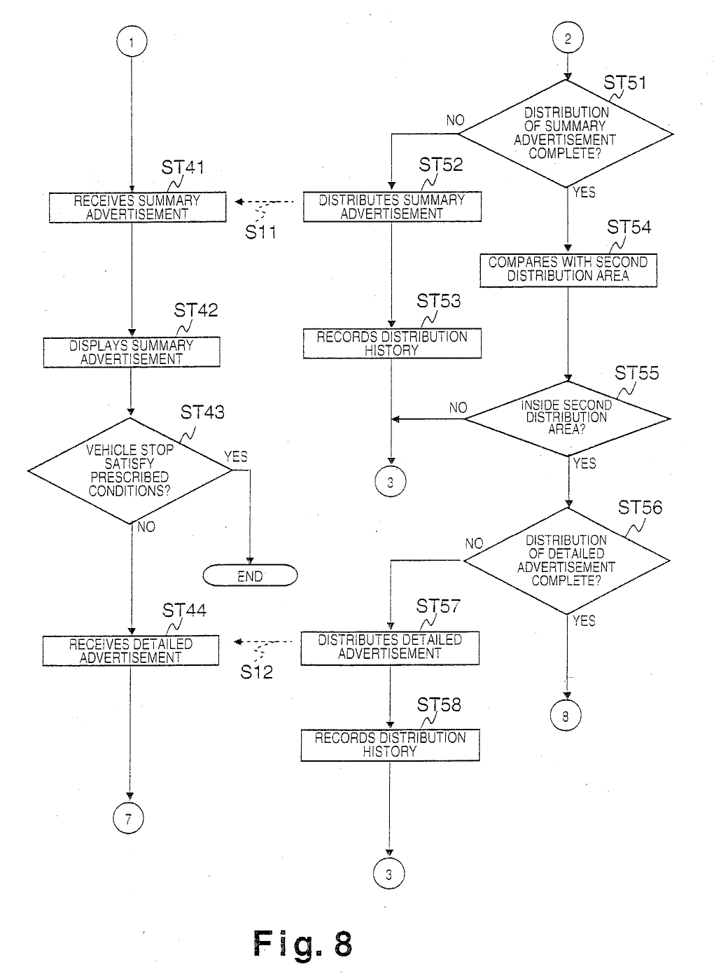

Then, in step ST51 illustrated in FIG. 8, the advertisement distribution system of the second embodiment determines if transmission of the summary advertisement information corresponding to the first distribution area information is complete by checking the distribution history. If there are summary advertisement information that have not yet been distributed, processing proceeds to step ST52 where summary advertisement information S11 are read from the advertisement information storage section 13 and distributed. Afterwards, the processing proceeds to step ST53, where the distribution history inside the advertisement information storage section 13 is recorded, and then returns to step ST23 of FIG. 3.

Meanwhile, when the advertisement distribution system of the second embodiment has determine that the distribution of the summary advertisement information corresponding to the first distribution area has been completed, processing proceeds to step ST54 of FIG. 8. In step ST54, the second area determining section 62 begins comparing the vehicle position with the second distribution area. From step ST55, processing either returns to step ST23 of FIG. 3 (when the mobile communication terminal 2 of the second embodiment determines that the vehicle is not positioned within the second distribution area) or proceeds to step ST56 of FIG. 8 (when the mobile communication terminal 2 of the second embodiment determines that the vehicle is positioned within the second distribution area).

In step ST56, the advertisement distribution device 1 determines if transmission of the detailed advertisement information corresponding to the second distribution area information is complete by checking the distribution history. If there are summary advertisement information that have not yet been distributed, the processing proceeds to step ST57 where detailed advertisement information S12 are read from the advertisement information storage section 13 and distributed. Afterwards, the processing proceeds to step ST58, where the distribution history inside the advertisement information storage section 13 is recorded, and returns to step ST23. Then, the advertisement distribution device 1 enters a waiting state to receive the operation input information S4 in response to the detailed advertisement.

After the mobile communication terminal 2 receives the summary advertisement information S11 through the transmitting/receiving section 42 in step ST41, processing proceeds to step ST42 where the summary advertisement is presented to the user by the display section 43.

After the summary advertisement has been presented, in step ST43, the mobile communication terminal 2 determines if the vehicle has been stopped in a manner that satisfies a prescribed set of conditions. These prescribed conditions refer to a state in which the vehicle has been stopped not momentarily as for a traffic signal, but in the manner described previously regarding step ST6 of the first embodiment. If the mobile communication terminal 2 has determined in step ST43 that the vehicle has stopped, the processing ends.

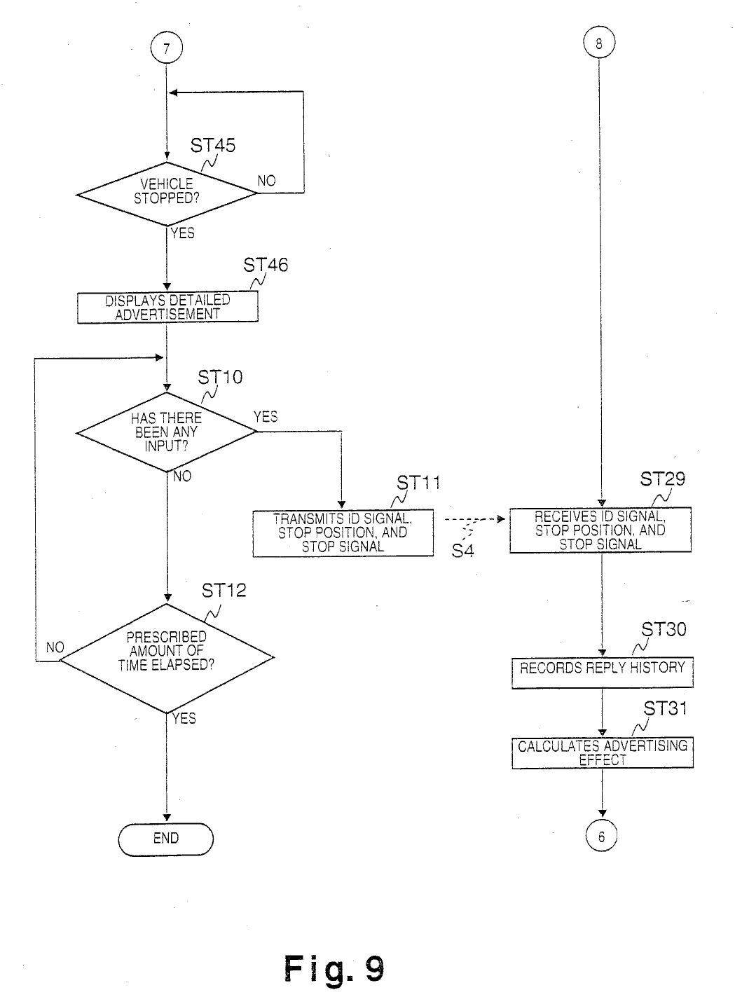

In step ST44, the detailed advertisement information S12 is received from the advertisement distribution device 1 in accordance with step ST57. Then, if the mobile communication terminal 2 has determined in step ST45 of FIG. 9 that the vehicle has stopped, the processing proceeds to step ST46 and the detailed advertisement is displayed. Then, after the detailed advertisement is displayed, the mobile communication terminal 2 of this second embodiment executes the processing of steps ST10 through ST12, as described previously, and the advertisement distribution device 1 of this second embodiment executes the processing of steps ST29 through ST31, as described previously.

### Effects of Second Embodiment

As described previously, with the second embodiment of the advertisement distribution system, a summary advertisement is distributed when the vehicle enters a first distribution area and, afterwards, a detailed advertisement is distributed when the vehicle enters a second distribution area. By detecting operations performed with respect to the detailed advertisement while the vehicle is inside the second distribution area, the system can reliably detect the user's intent regarding visiting the advertised establishment and the analyze the advertising effect accordingly.

Furthermore, since this advertisement distribution system does not distribute the detailed advertisement information until the vehicle enters the second distribution area, the system can avoid distributing large amounts of information to users who were not interested in the advertisement when the summary advertisement was presented and the quantity of information distributed by the system as a whole can be reduced.

### Third Embodiment

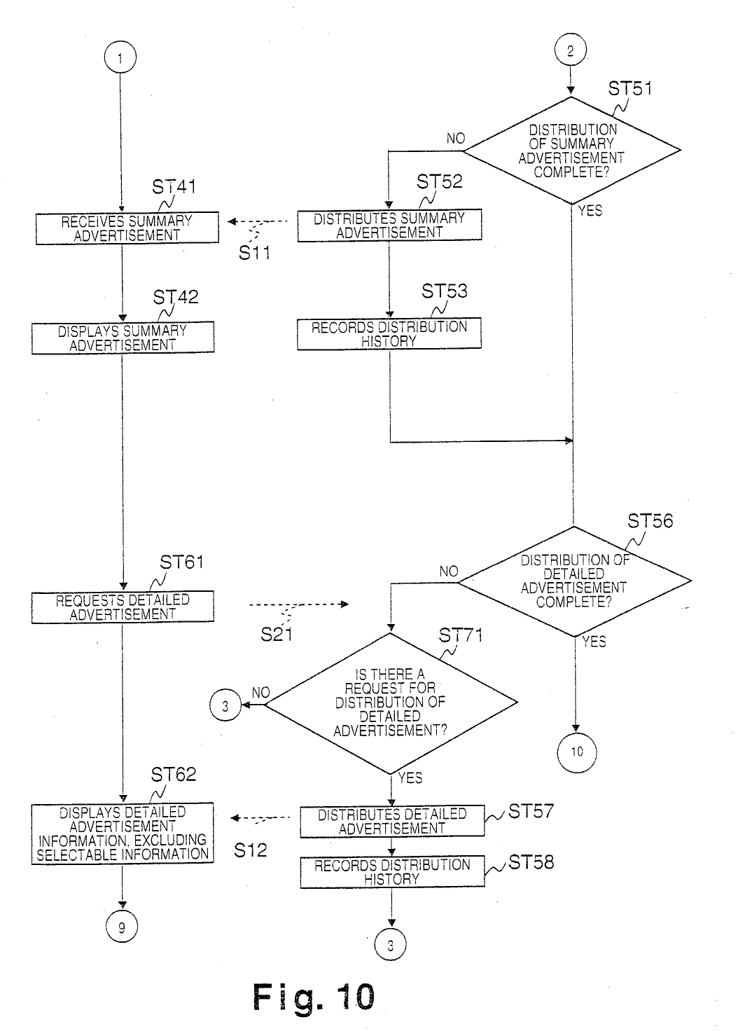

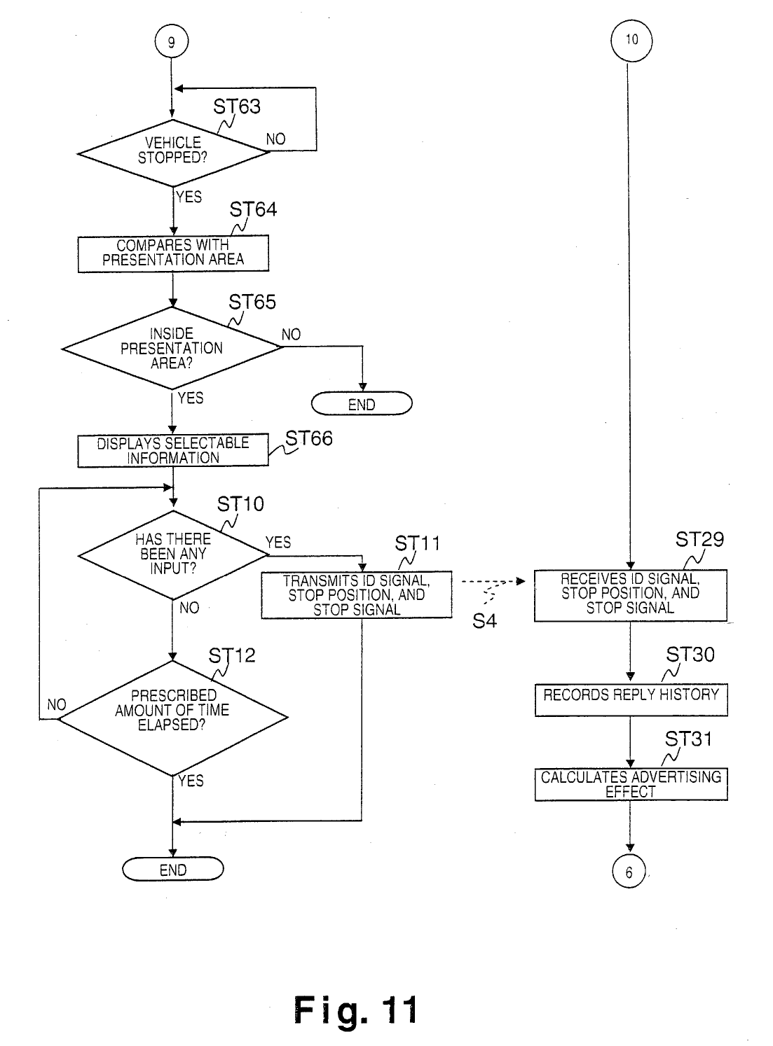

Referring now mainly to FIGS. 10 and 11, a third embodiment of an advertisement distribution system in accordance with the present invention will be described. Regarding portions of the third embodiment that are the same as the previously described embodiments, the same reference symbols and same step numbers are used. Also, the detailed explanations of these repeated portions are omitted.

The third embodiment of the advertisement distribution system basically the same as the first embodiment, except in one basic respect. In particular, in the advertisement distribution system of the third embodiment of the advertisement distribution system differs from the previously described embodiments in that after the summary advertisement information is distributed to the mobile communication terminal 2, the detailed advertisement information is distributed in accordance with a detailed advertisement distribution request and selectable content which is displayed when the vehicle has entered the presentation or second distribution area.

The processing executed by this advertisement distribution system is illustrated and described in reference to the flowcharts in FIGS. 3, 10 and 11. First, as shown in FIG. 3, the mobile communication terminal 2 of this third embodiment executes the processing of steps ST1 through ST3, as described previously, and the advertisement distribution device 1 of this third embodiment executes the processing of steps ST21 through ST25, as described previously.

In this advertisement distribution system of the third embodiment, after the mobile communication terminal 2 has received and displayed the summary advertisement information from the advertisement distribution device 1, the processing proceeds to step ST61. In step ST61 of FIG. 10, a detailed advertisement information distribution request S21 is transmitted from the mobile communication terminal 2 to the advertisement distribution device 1 due to, for example, an operation performed on the operation input section 44 by the user. An ID signal of the mobile communication terminal 2 and information identifying the requested detailed advertisement are attached to the distribution request S21.

Meanwhile, in step ST56 of FIG. 10, the advertisement distribution device 1 determines if any detailed advertisement information that has not yet been distributed exist among the detailed advertisement information related to the previously distributed summary advertisement information. If so, the processing proceeds to step ST71 of FIG. 10 where the advertisement distribution device 1 determines if the distribution request S21 has been received from the mobile communication terminal 2. If the advertisement distribution device 1 has not received the distribution request S21, then the processing returns to step ST23. If the advertisement distribution device 1 has received the distribution request S21, then the processing proceeds to step ST57 where the detailed advertisement information indicated in the distribution request S21 are read from the advertisement information storage section 13 and transmitted.

After receiving the detailed advertisement information indicated in the distribution request S21, the mobile communication terminal 2 proceeds to step ST62 of FIG. 10 where the mobile communication terminal 2 displays the detailed advertisement using display information that presents advertisement that is more detailed than the summary advertisement displayed in step ST42. Here, the display information processing section 54 processes in such a manner that the display screen or display section 43 does not display icons and other selectable items that can be selected by the user.

After the detailed advertisement is displayed, the mobile communication terminal 2 determines if the vehicle has stopped in step ST63 of FIG. 11. If the vehicle has stopped, the mobile communication terminal 2 proceeds to step ST64 of FIG. 11 where the mobile communication terminal 2 checks the vehicle position against the presentation area and proceeds to step S65. In step ST65 of FIG. 11, the mobile communication terminal 2 determines if the vehicle is located within the presentation area. If the vehicle is located within the presentation area, selectable content is displayed on the display section 43 in step ST66 of FIG. 11. After displaying the selectable content, the mobile communication terminal 2 executes the processing of steps ST10 through ST12 of FIG. 11 in the same manner as described previously with reference to FIG. 5 of the first embodiment.

### Effects of Third Embodiment

In the third embodiment of the advertisement distribution system, the detailed advertisement is distributed in response to the distribution request S21 after the summary advertisement is displayed and the selectable content is displayed when the vehicle is stopped in the presentation area. The operations performed by the user with respect to the detailed advertisement can be detected and the same effects as the previously described embodiments can be obtained. With this advertisement distribution system, the user can request a detailed advertisement to be presented even when the vehicle is not inside the presentation area of the detailed advertisement and the advertising effect can be analyzed accurately by displaying selectable content when the vehicle is inside the presentation area.

Although this third embodiment is configured such that the detailed advertisement is distributed from the advertisement distribution device 1 when a request for the detailed information related to the summary advertisement is issued from the mobile communication terminal 2, but it is also acceptable to arrange the advertisement distribution system such that the position of the mobile communication terminal 2 is detected when the mobile communication terminal 2 issues the distribution request S21 and the advertisement information to be distributed is selected in response to the position of the mobile communication terminal 2. As a result, advertisements for establishments that are closer to the vehicle can be presented to the user and the advertising effect can be increased.

### Fourth Embodiment

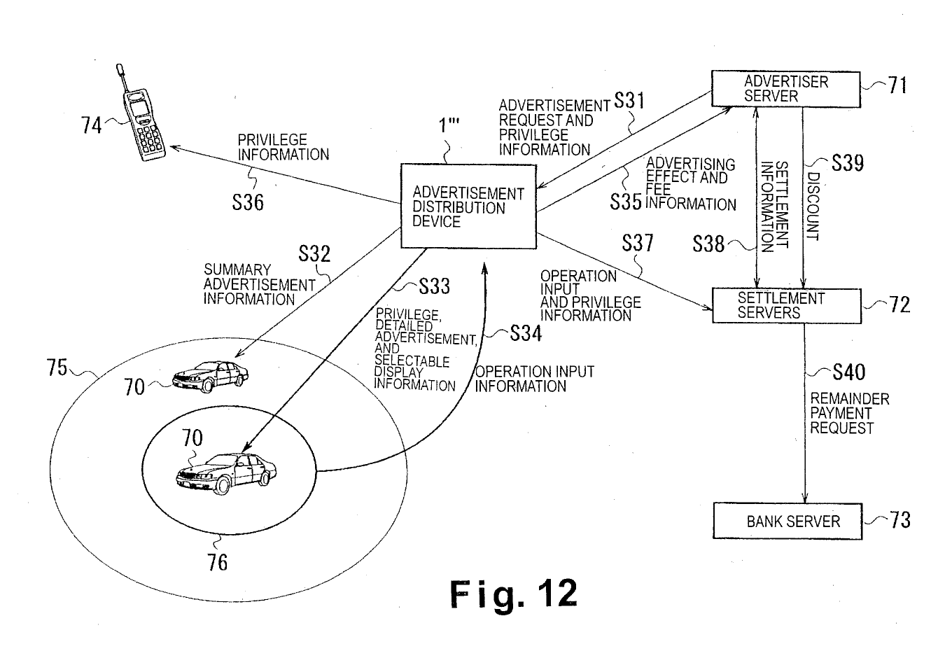

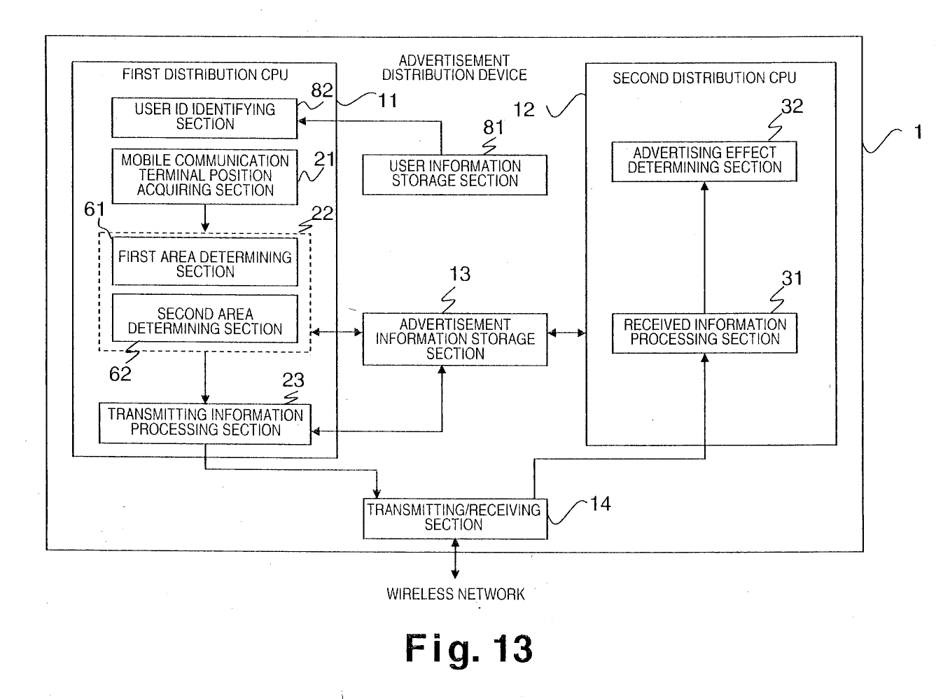

Referring now to FIGS. 12 and 13, a fourth embodiment of an advertisement distribution system in accordance with the present invention will be described. Regarding portions of the fourth embodiment that are the same as the previously described embodiments, the same reference symbols and same step numbers are used. Also, the detailed explanations of the repeated portions are omitted.

As shown in FIG. 12, the fourth embodiment of the advertisement distribution system includes an advertiser server 71, a settlement server 72, a bank server 73 and a portable telephone terminal 74. The advertiser server 71 is configured to request distributions of advertisement information stored in the advertisement distribution device 1. The settlement server 72 is configured to calculate and settle privileges such as discounts accompanying distributed advertisements. The bank server 73 is configured to manage user accounts. The portable telephone terminal 74 that is held by the user is configured to communicate through the wireless network to the advertisement distribution device 1.

As shown in FIG. 13, the advertisement distribution device 1 of this fourth embodiment of the advertisement distribution system includes all of the sections of the advertisement distribution device 1 of the second embodiment plus a user information storage section 81 and a user ID identifying section 82 that identifies user IDs.

The user information storage section 81 stores user identification information related to users who receive the advertisement distribution service. This user identification information comprises, but not limited to, information regarding the settlement server 72 that the user uses for settlement of accounts. The user ID identifying section 82 serves to acquire an ID signal from the mobile communication terminal 2 when a member user moves together with the mobile communication terminal 2. By comparing this ID signal with the user identification information stored in the user information storage section 81, the advertisement distribution device 1 identifies the settlement server 72 for the user to whom an advertisement is being distributed. Thus, the user information storage section 81 correlates the settlement server 72 of the advertiser of the distributed advertisement distributed with the user that is acting on the distributed advertisement.

In this advertisement distribution system, when the advertisement distribution device 1 receives advertisement distribution request information and privilege information S31 from the advertiser server 71, it registers this information by storing them as advertisement information in the advertisement information storage section 13. The advertisement distribution request information portion of the advertisement distribution request information and privilege information S31 includes area information for distributing and presenting the advertisement, summary advertisement information, detailed advertisement information, and selectable display information. The privilege information portion of the advertisement distribution request and privilege information S31 includes information regarding privileges generated by accepting a service offered by the advertiser.

By executing the previously described processing between the advertisement distribution device 1 and the mobile communication terminal 2, summary advertisement information S32 is distributed and privilege information, detailed advertisement information, and selectable display information S33 are also distributed. The privilege information and the detailed advertisement information are presented to the user, and the operation input information S34 is then generated in response to the selectable content, which is transmitted to the advertisement distribution device 1.

Here, it is also possible to display selectable content regarding the settlement server(s) 72, such as a display prompting settlement using a settlement server offered by the advertiser or a display allowing the user to select the settlement server he or she uses normally, and acquire the operation input information S34 based on the operation input of the user. The selectable content that allows the user to select the service content offered by the advertiser can also be displayed.

Thus, the advertising effect can be analyzed by displaying the selectable content, i.e., content prompting such actions as selecting the settlement server and selecting services that the user will accept, and using the advertisement distribution device 1 to detect the operations input by the user when the settlement method and service details are presented.

When the advertisement distribution device 1 receives the operation input information S34, the advertisement distribution device 1 analyzes the advertising effect at the advertising effect determining section 32, creates fee information with respect to the calculation of the advertising effect, and sends the advertisement distribution effect and fee information S35 to the advertiser server 71. As a result, the advertisement distribution device 1 enables to obtain a profit from having distributed an advertisement in response to a request from the advertiser. Moreover, the advertiser can learn the effect on the user of the distributed advertisement through the advertiser server 71.

Also, when the user selects selectable content related to a privilege on the mobile communication terminal 2 and the advertisement distribution device 1 receives the operation input information S34 indicating that a privilege will be obtained as a result of accepting an advertised service, the privilege information S36 is then transmitted to the portable telephone terminal 74 and presented to the user. The privilege information S36 that is transmitted to the portable telephone terminal 74 and presented to the user indicates that a privilege of some kind, such as a discount coupon, will be bestowed onto the user. At the same time, the operation input information and the privilege information S37 are sent to the settlement server 72.

From this state, if, for example, the user purchases a product from the store advertised by the advertiser, the settlement information S38 is exchanged between the advertiser server 71 and the settlement server 72 to complete the transaction. Here, the advertiser server 71 provides the settlement server 72 with a discount S39 resulting from the user designating a settlement or payment method and purchasing the product at the advertiser's store. The settlement server 72 subtracts the privilege or discounted portion and requests payment for the remainder by sending the remainder information S40 to the bank server 73. This is accomplished based on the operation input information and privilege information S37 from the advertisement distribution device 1 and the discount S39 from the advertiser server 71.

This fourth embodiment of the advertisement distribution system enables the construction of a system that provides both an advertisement distribution service and an advertising effect determination service in which a summary advertisement can be distributed to a traveling vehicle 70 when the vehicle is inside a first area 75, a detailed advertisement and selectable content can be displayed when the vehicle is inside a second area 76, and a fee is requested from the advertiser server 71 in response to an operation input detected by the advertisement distribution device 1.

This advertisement distribution system enables privilege information to be presented to a user in conjunction with a detailed advertisement and a privilege such as a discount to be bestowed upon the user by presenting the privilege via the portable telephone terminal 74. The privilege can be settled through information exchanges made between the advertiser server 71, the settlement server 72, and the bank server 73. Thus, the user can be provided with benefits for viewing an advertisement and the popularity and profitability of the advertisement distribution service as a whole can be improved.

This advertisement distribution system makes it possible to determine the advertisement distribution effect in a reliable manner and makes it easy for an advertisement distributor to construct a business. Thus, a system can be constructed in which the services that the user can enjoy are clear and benefits can be enjoyed by the advertisement distributor, the advertiser, and the user.

Regarding the transmission of privilege information S36 from the advertisement distribution device 1 to the portable telephone terminal 74, it is also acceptable to, for example, record the e-mail address of the portable telephone terminal 74 in the user information storage section 81 and notify the user in an email format. With this arrangement, should the user visit the advertiser's store, he or she will be able to receive the service with certainty (without forgetting what the service was) and also receive privileges.

When cash is selected as the settlement method, the user can show the privilege information received by the portable telephone terminal 74 to the store clerk and thereby receive the privilege.

### Effects of Fourth Embodiment

In addition to the effects of the previously described embodiments, this fourth embodiment achieves other advantages. For example, with the advertisement distribution processing system of this fourth embodiment, information is transmitted to the communication terminal 2 for selecting a settlement server that is sponsored by the advertiser from among the settlement servers used by the user and operations selecting any settlement server are detected as operation input information of the communication terminal 2 with respect to the advertisement. As a result, the advertising effect with respect to the user, as well as the user's selection of the settlement section sponsored by the advertiser, can be analyzed simultaneously. The settlement server performs settlement processing for a payment generated regarding the user and the user is provided with privileges based on the privilege information. As a result, the user can receive the privileges in a reliable manner.

With this advertisement distribution processing system, the advertisement distribution device 1 transmits the privilege information to a portable information device held by the user. As a result, privilege information can be presented via portable information device even when settlement was completed using cash, for example.

Moreover, although the previously described embodiments concerned configurations in which the mobile communication terminal 2 was installed in a vehicle, the invention is not limited to such a configuration. It is also acceptable to transmit the advertisement information and other information to a portable telephone terminal or PDA (Personal Digital Assistant) held by a pedestrian and to detect the operations performed on the portable telephone terminal or PDA.

While the first through fourth embodiments were described as distinctive configurations, the present invention is not limited to those configurations and the same effects can be obtained by using any combination of those embodiments.

Furthermore, although the previously described embodiments concerned configurations in which the advertisement information to be distributed was stored in the advertisement distribution device that existed in a network, the present invention is not limited to such a configuration. The same effects can be obtain by storing advertisement content information on a recording medium located in the vehicle, presenting relevant advertisements in response to the position of the vehicle, and calculating the advertising effect by detecting the operation input information through a network.

The term “configured” as used herein to describe a component, section or part of a device of any one of the previously described embodiments includes hardware and/or software that is constructed and/or programmed to carry out the desired function.

Moreover, terms that are expressed as “section-plus function” in the claims should include any structure that can be utilized to carry out the function of that part of the present invention.

The terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

This application claims priority to Japanese Patent Application No. 2002-145306. The entire disclosure of Japanese Patent Application No. 2002-145306 is hereby incorporated herein by reference.

While only selected embodiments have been chosen to illustrate the present invention, it will be apparent to those skilled in the art from this disclosure that various changes and modifications can be made herein without departing from the scope of the invention as defined in the appended claims. In other words, other configurations, including various modifications related to design factors and the like, are also possible so long as they do not deviate from the technical concepts of the invention. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. An advertisement distribution processing system comprising:
a communication terminal configured to receive advertisement content information and present to a user an advertisement based on the advertisement content information; and
an advertisement distribution device configured to associate and store in advance the advertisement content information and area information indicating an area where the advertisement will be presented,
the advertisement distribution device being further configured to distribute the advertisement content information corresponding to the area information of the area to the communication terminal when the communication terminal is located within the area,
the advertisement distribution device being further configured to detect operation input information created by operations performed on the communication terminal in response to the advertisement, and analyze an advertising effect based on the operation content.

2. The advertisement distribution processing system as recited in claim 1, wherein
the communication terminal is configured as a mobile communication terminal that moves with the user who receives the advertisement.

3. The advertisement distribution processing system as recited in claim 1, further comprising
a plurality of settlement servers configured to communicate with the advertisement distribution device to settle payments generated by the user using the communication terminal, and
the advertisement distribution device being further configured to identify a user ID assigned to the communication terminal, search among the settlement servers for at least one that corresponds to the user ID that was identified, transmit to the communication terminal information for selecting the settlement server associated with an advertiser from among the settlement servers, and detect the operation input information created by a selection operation performed on the communication terminal that selects one of the settlement servers with respect to the advertisement.

4. The advertisement distribution processing system as recited in claim 3, wherein
the advertisement distribution device is further configured to transmit to the settlement server that was selected advertiser information identifying the advertiser who requested advertisement distribution, user identification information, and privilege information assigning a privilege to the user relating to payment of an offer in the advertisement, and
the settlement servers are further configured to perform settlement processing for user payment based on the advertiser information, the user identification information and the privilege information.

5. The advertisement distribution processing system as recited in claim 4, wherein
the advertisement distribution device is further configured to transmit the privilege information to a portable hand held information device.

6. An advertisement distribution device comprising:
a communication section configured to communicate with a communication terminal to which an advertisement will be distributed;
a memory section configured to associate and store advertisement content information containing the advertisement and distribution area information indicating a distribution area where the advertisement will be distributed;
a position acquisition section configured to acquire position information indicating a current location of the communication terminal; and
an advertisement distribution processing section configured to control the communication section to read from the memory section the advertisement content information corresponding to the distribution area information of the distribution area, and distribute the advertisement content information to the communication terminal upon a determination by the position acquisition section that the communication terminal is located within the distribution area based on the position information acquired, and
the advertisement distribution processing section being further configured to analyze an advertising effect by detecting operation input information created by operations performed on the communication terminal in response to the advertisement.

7. The advertisement distribution device as recited in claim 6, wherein
the memory section is further configured to associate and store summary advertisement content information that presents an advertisement summary, summary distribution area information that identifies a summary distribution area where the summary advertisement content information will be distributed, detailed advertisement content information that presents a detailed advertisement having more details than the advertisement summary, and detail distribution area information that identifies a detail distribution area where the detailed advertisement will be distributed, and
the advertisement distribution processing section is further configured to control the communication section such that the communication section reads the summary advertisement content information from the memory section and distributes the summary advertisement content information to the communication terminal upon a determination that the communication terminal is located within the summary distribution area,
the advertisement distribution processing section is further configured to control the communication section such that the communication section reads the detailed advertisement content information from the memory section and distributes the detailed advertisement content information to the communication terminal upon a determination that the communication terminal is located within the detail distribution area, and analyzes the advertising effect by detecting the operation content of the communication terminal after the detailed advertisement content information has been distributed.

8. The advertisement distribution device as recited in claim 6, wherein
the memory section is further configured to associate and store summary advertisement content information that presents an advertisement summary, detailed advertisement content information that presents a detailed advertisement having more details than the advertisement summary, distribution area information that identifies a distribution area where the summary advertisement content information and detailed advertisement content information will be distributed, and presentation area information that identifies a presentation area of a smaller area than the distribution area where the detailed advertisement will be presented, and
the advertisement distribution processing section is further configured to control the communication section to read the summary advertisement content information, the detailed advertisement content information and the presentation area information from the memory section and then distribute the summary advertisement content information, the detailed advertisement content information and the presentation area information to the communication terminal upon a determination by the advertisement distribution processing section that the communication terminal is located within the distribution area, and
the advertisement distribution processing section is further configured to analyze the advertising effect by detecting the operation content of the communication terminal after the detailed advertisement has been presented in the presentation area.

9. The advertisement distribution device as recited in claim 6, further comprising
a route acquisition section configured to acquire recommended route information for a vehicle from the communication terminal, and
the advertisement distribution processing section being further configured to distribute the advertisement content information when the recommended route acquired by the route acquisition section passes through the distribution area.

10. The advertisement distribution device as recited in claim 6, wherein
the advertisement distribution processing section is further configured to read and distribute the advertisement content information stored in the memory section in response to the position information acquired from the communication terminal through the communication.

11. The advertisement distribution device as recited in claim 6, wherein
the memory section includes selectable display information stored that is associated with the advertisement content information and that is used to prompt selection operations via the communication terminal, and
the advertisement distribution processing section is further configured to distribute the selectable display information along with the advertisement content information to the communication terminal, and detect the selection operations performed on the communication terminal as the operation content of the communication terminal in response to the advertisement.

12. An advertisement distribution processing method comprising:
storing in advance advertisement content information corresponding to at least one advertisement to be distributed;
storing in advance distribution area information indicating a distribution area corresponding to the advertisement to be distributed;
monitoring location of a communication terminal to which the advertisement will be distributed;
distributing to the communication terminal the advertisement content information corresponding to the distribution area information of the distribution area when the location of the communication terminal has entered the distribution area;
detecting operation input information created by operation of the communication terminal in response to the advertisement; and
analyzing the operation input information to determine an advertising effect of the advertisement content information.

13. The advertisement distribution processing method as recited in claim 12, further comprising
storing in advance summary advertisement content information that presents an advertisement summary;
storing in advance summary distribution area information that identifies a summary distribution area where the summary advertisement content information will be distributed;
storing in advance detailed advertisement content information that presents a detailed advertisement that is more detailed than the advertisement summary;
storing in advance detail distribution area information that identifies a detail distribution area where the detailed advertisement will be distributed;
distributing summary advertisement content information to the communication terminal when it is determined that the communication terminal is positioned within the summary distribution area; and
distributing detailed advertisement content information to the communication terminal after the summary advertisement content information has been distributed and upon a determination that the communication terminal is located within the detail distribution area, and
the detecting of the operation of the communication terminal and the analyzing of the advertising effect occurring after the detailed advertisement content information has been distributed.

14. The advertisement distribution processing method as recited in claim 12, further comprising
storing in advance summary advertisement content information that presents an advertisement summary;
storing in advance detailed advertisement content information that presents a detailed advertisement that is more detailed than the advertisement summary;
storing in advance distribution area information that identifies a distribution area where the summary advertisement content information and the detailed advertisement content information will be distributed;
storing in advance presentation area information that identifies a presentation area where the detailed advertisement content information will be presented; and
distributing the summary advertisement content information, the detailed advertisement content information, and the presentation area information to the communication terminal upon a determination that the communication terminal is located within the distribution area, and
the detecting of the operation of the communication terminal and the analyzing of the advertising effect occurring after the detailed advertisement has been presented in the presentation area.

15. The advertisement distribution processing method as recited in claim 12, further comprising
acquiring from the communication terminal recommended route information for a vehicle from the communication terminal; and
distributing the advertisement content information upon a determination that the recommended route acquired by the route acquisition section passes through the distribution area.

16. The advertisement distribution processing method as recited in claim 12, wherein
the distributing of the advertisement content information occurs upon accessing the communication terminal to acquire the location of the communication terminal.

17. The advertisement distribution processing method as recited in claim 12, further comprising
storing in advance selectable display information that prompts a selection operation of the communication terminal in response to the advertisement content information received by the communication terminal;
distributing the selectable display information to the communication terminal when the advertisement content information is distributed to the communication terminal; and
detecting the selection operation performed on the communication terminal as a part of the operation input information of the communication terminal.

18. A communication terminal comprising:
a communication section configured to communicate with an advertisement distribution device that distributes advertisement content information;
an information presentation section configured to present an advertisement based on the advertisement content information to a user;
a position acquisition section configured to acquire position information indicating a current location of the communication terminal;
an input section configured to input commands using operations performed by the user;
a control section configured to control the information presentation section to present the advertisement when the communication section has received the advertisement content information from the advertisement distribution device and presentation area information indicating a presentation area where the advertisement will be presented, and upon a determination based on the position information acquired by the position acquisition section that the current location is within the presentation area,
the control section being further configured to create operation input information based on the operations inputted to the input section in response to the advertisement having been presented by the information presentation section, and control the communication section to transmit the operation input information to the advertisement distribution device.

19. The communication terminal as recited in claim 18, wherein
the communication terminal is configured as a mobile communication terminal that moves with the user who receives the advertisement.

20. The communication terminal as recited in claim 18, wherein
the control section is further configured to distinguish between summary advertisement content information and detailed advertisement content information that are contained within the advertisement content information received by the communication section from the advertisement distribution device,
the control section is further configured to control the information presentation section to present to the user an advertisement summary based on the summary advertisement content information upon determining based on the position information acquired by the position acquisition section that the current location of the communication terminal position is within a distribution area that is larger than the presentation area,
the control section is further configured to control the information presentation section to present to the user a detailed advertisement having more details than the advertisement summary based on the detailed advertisement content information upon determining based on the position information acquired by the position acquisition section that the current location of the communication terminal is within the presentation area;
the control section is further configured to detect the operation content inputted to the input section after the detailed advertisement content information has been presented, and
the communication section is further configured to transmit the operation input information to the advertisement distribution device.

21. The communication terminal as recited in claim 18, wherein
the communication section is further configured to receive selectable display information that is associated with the advertisement content information and serves to prompt a selection operation of the input section; and
the control section is further configured to control the information presentation section to display selectable content based on the selectable display information along with the advertisement and create operation input information based on the selection operations inputted to the input section in response to a selection of the selectable content.

22. The communication terminal as recited in claim 21, wherein
the control section is further configured to control the information presentation section to display the selectable content along with the advertisement upon determination a stopping operation has occurred that is indicative of a vehicle equipped with the communication terminal is stopping.

23. An advertisement presentation method comprising:
receiving advertisement content information and presentation area information in a communication device from an advertisement distribution device, with the presentation area information indicating a presentation area where an advertisement will be presented;
acquiring position information indicative of a current location of the communication device;
presenting the advertisement to a user of the communication device upon determining that the current location of the communication device is within the presentation area based on the position information acquired;
creating operation input information based on operations inputted by the user in response to the advertisement having been presented; and
transmitting the operation input information to the advertisement distribution device.

24. The advertisement presentation method as recited in claim 23, wherein
the presenting of the advertisement content information includes presenting an advertisement summary based on summary advertisement content information, a detailed advertisement that is more detailed than the advertisement summary based on detailed advertisement content information,
receiving in the communication device presentation area information that identifies a presentation area where the detailed advertisement content information will be presented;
presenting the summary advertisement to the user upon determining based on the position information acquired that the current location of the communication device is within a distribution area that is larger than the presentation area;
presenting the detailed advertisement to the user upon determining based on the position information acquired that the current location of the communication device is within the presentation area;
detecting the operation input information inputted by the user after presenting the detailed advertisement; and
transmitting the operation input information to the advertisement distribution device.

25. The advertisement presentation method as recited in claim 23, wherein
receiving in the communication device selectable display information that is associated with the advertisement content information and serves to prompt a selection operation by the user;
displaying selectable content based on the selectable display information along with the advertisement; and
creating the operation input information based on the selection operation inputted by the user in response to a selection of the selectable content.

26. The advertisement presentation method as recited in claim 23, wherein
the displaying of the selectable content along with the advertisement occurs upon determination that a stopping operation has occurred that is indicative of a vehicle equipped with the communication device is stopping.

27. An advertisement distribution processing system comprising:
communication means for receiving advertisement content information and presenting to a user an advertisement based on the advertisement content information; and
advertisement distribution means for associating and storing in advance the advertisement content information and area information indicating an area where the advertisement will be presented,
the advertisement distribution means being further configured to distribute the advertisement content information corresponding to the area information of the area to the communication means when the communication means is located within the area,
the advertisement distribution means being further configured to detect operation input information created by operations performed on the communication means in response to the advertisement, and analyze an advertising effect based on the operation input information.

28. An advertisement distribution device comprising:
communication means for communicating with a communication terminal to which an advertisement will be distributed;
memory section means for associating and storing advertisement content information containing the advertisement and distribution area information indicating a distribution area where the advertisement will be distributed;
position acquisition means for acquiring position information indicating a current location of the communication means; and
advertisement distribution processing means for controlling the communication means to read from the memory means the advertisement content information corresponding to the distribution area information of the distribution area, and distribute the advertisement content information to the communication means upon a determination by the position acquisition means that the communication means is located within the distribution area based on the position information acquired, and the advertisement distribution processing means being further configured to analyze an advertising effect by detecting operation input inforamation created by operations performed on the communication means in response to the advertisement.

29. A communication terminal comprising:
communication means for communicating with an advertisement distribution device that distributes advertisement content information;
information presentation means for presenting an advertisement based on the advertisement content information to a user;
position acquisition means for acquiring position information indicating a current location of the communication means;
input means for inputting commands using operations performed by the user;
control means for controlling the information presentation means to present the advertisement when the communication means has received the advertisement content information from the advertisement distribution device and presentation area information indicating a presentation area where the advertisement will be presented, and upon a determination based on the position information acquired by the position acquisition means that the current location is within the presentation area,
the control means being further configured to create operation input information based on the operations inputted to the input means in response to the advertisement having been presented by the information presentation means, and control the communication means to transmit the operation input information to the advertisement distribution device.
